(19) United States
(12) Patent Application Publication
(10) Pub. No.: US 2022/0117173 A1
(43) Pub. Date: Apr. 21, 2022

(54) FLUID DISTRIBUTION SYSTEM HAVING A MULTI-HOP CONTROL AND/OR COMMUNICATION NETWORK ASSOCIATED THEREWITH

(71) Applicant: NETAFIM, LTD., Tel Aviv (IL)

(72) Inventor: ABRAHAM SCHWEITZER, KIBBUTZ HATZERIM (IL)

(73) Assignee: NETAFIM, LTD., TEL AVIV (IL)

(21) Appl. No.: 17/565,899

(22) Filed: Dec. 30, 2021

Related U.S. Application Data
(63) Continuation-in-part of application No. PCT/IB2020/056196, filed on Jun. 30, 2020.
(60) Provisional application No. 62/869,583, filed on Jul. 2, 2019.

(51) Int. Cl. A01G 25/16; H04B 10/278; H04B 10/40; H04Q 11/00

(52) U.S. Cl. CPC A01G 25/16; H04B 10/278; H04Q 2213/08; H04Q 11/0062; H04Q 2011/0073; H04B 10/40

(57) ABSTRACT

A system includes a longitudinally extending infrastructure, for example a piping infrastructure, and a plurality of nodes located along the infrastructure. The system further includes communication channels that extend along the infrastructure that communicate with the nodes for permitting multi-hop routing of messages between nodes along the infrastructure.

### RELATED APPLICATIONS

This is a Bypass Continuation-in-Part of International Application no. PCT/IB2020/056196 filed 30 Jun. 2020 and published as WO 2021/001758A1, which claims priority to U.S. Provisional Patent Application No. 62/869,583, filed 2 Jul. 2019. The contents of the aforementioned applications and publication are incorporated by reference in their entirety.

### TECHNICAL FIELD

Embodiments of the invention relate to infrastructural lines and control and/or communication networks associated therewith, where such infrastructural lines can for example be piping infrastructural lines. Such piping infrastructural lines may be part of a fluid distribution system for gases, liquids and the like, such as those distributed by an irrigation system.

### BACKGROUND

Various industries include infrastructure that may typically be provided along paths in an environment that the infrastructure is planned to serve or traverse. Examples may include electrical cables or wirings, liquid or gas conducting piping laid on or below ground (etc.). One example of a piping infrastructure may be in agriculture where irrigation lines are typically laid along paths in a field.

Advantages may be envisioned for provision of control and/or communication networks along such infrastructures, which may be able to manage, command, direct, monitor or regulate zones or sectors along such infrastructures.

US20150292319 for example describes a system that employs a series of communication nodes spaced along a tubular body either above or below ground. The nodes allow for wireless communication between one or more sensors residing at the level of a subsurface formation or along a pipeline, and a receiver at the surface.

WO2019016684 for example describes an irrigation system that includes fluid conducting tubes with drip segments extending alongside each fluid conducting tube. The system further includes a plurality of zone valves and control tubes for activating the control valves e.g. to irrigate distinct zones in a field.

### SUMMARY

The following embodiments and aspects thereof are described and illustrated in conjunction with systems, tools and methods which are meant to be exemplary and illustrative, not limiting in scope.

An aspect of the present invention generally relates to a system comprising a network of control devices (nodes) suitable for operating, monitoring and/or controlling infrastructure laid along a path in an environment.

In certain embodiments, the infrastructure may be a piping infrastructure comprising a plurality of control nodes located along a piping line.

Nodes may be arranged to sense and/or collect data from the infrastructure and/or an environment of the infrastructure and/or activate actions such as hydraulic actions along the piping infrastructure.

Nodes along the piping infrastructure may be arranged for communication via one or more communication channels.

In certain embodiments, such communication channels may come in form of one or more optical fibers extending along a length of the piping/infrastructure.

Optical fibers according to certain embodiments of the invention may be plastic optical fiber (POF). Plastic optical fibers are typically of a relative low cost, can be easily integrated with certain types of pipes, e.g. polymer pipes such as polyethylene, and can be relatively easily spliced in field conditions.

Optical fibers according to certain embodiments of the invention may be arranged for linear bus topology in which nodes are connected one after the other in a sequential chain.

In certain embodiments, such communication channels may come in the form of one or more electrical conductors extending along a length of the piping. Such electrical conductors may comprise material that allows the flow of electrical current in one or more directions therealong.

In at least certain embodiments, communicating via communication channels over a network communication may comprise multi-hop routing where a node can use other nodes as relays. Possibly, such multi-hop routing may be in the form of a daisy chain topology where multiple nodes are wired together in sequence. In some cases, said daisy chain topology may be linear and/or tree daisy chain topology.

In such multi-hop routing, optical or electrical signals conveying messages and/or commands may be relayed between relatively closely sequential placed nodes that are spaced apart one from the other by relative short distances (e.g. about 50 meters apart or the like).

Such relaying from node to node may be in downstream and/or upstream directions along a piping infrastructure.

In certain embodiments, a given message communicated downstream may trigger formation of a return message that is substantially immediately communicated back upstream e.g. to a controller transmitting and/or receiving such messages. In a communication network comprising ‘n’ nodes interconnected by communication channels, such communication may be characterized by communicating a message downstream from or through node ‘1’ towards node ‘n’ and then back upstream from or through node ‘n’ towards node ‘1’.

In certain embodiments, the information capacity of such given message communicated downstream (as measured at least adjacent a downstream end of a communication network) may be generally equal to or possibly smaller or larger than the information capacity returning back upstream (as measured at least adjacent an upstream end of the communication network).

A capacity of a message communicated downstream may be smaller than a returning upstream message e.g. during actuation of a “check” procedure aimed at inquiring whether one or more nodes along the infrastructure are responsive (e.g. in functioning order). A capacity of a message communicated downstream may be larger than a returning upstream message e.g. during actuation of a “status” procedure aimed at inquiring a status (e.g. open/close, etc.) of node(s) along the infrastructure. In some cases, a capacity of a message communicated downstream may be generally similar to that of a returning upstream message.

Typically, ‘capacity’ may be defined according to “message length”, including e.g. a ‘payload’ portion being a part of transmitted communication comprising the actual intended message and headers and metadata that may be sent to enable payload delivery.

In the case of communication channels being in form of optical fibers, multi-hop routing between closely spaced apart nodes may facilitate use of optical fibers with relative large fiber attenuation (such as in the case of at least certain POF's) along relative large distances, since loss of light in such embodiments may be mitigated by the short distance light travels or traverses between nodes.

In certain embodiments comprising optical fibers as the communication channels, light emitted from a first node at an initial outgoing intensity typically arrives at a relative adjacent second sequential node at a lower terminal intensity due to fiber attenuation. At the second subsequent and adjacent node, an arriving command and/or message conveyed by the light signal may be interpreted, decoded and/or modulated and then relayed onwards away from such second node at an intensity generally similar to the initial outgoing intensity towards a third adjacent and subsequent node (and so on). In this manner, a received light signal is boosted to its initial outgoing intensity, as it leaves each successive node along the line, and this boosting may occur in either or both the upstream and downstream directions.

Such multi hop routing may thus permit relative large transmission ranges with fibers having relative high attenuation (such as at least certain POF's), however while keeping relative low overall fiber attenuation along the entire length of path that such messages traverse.

To reduce power consumption, systems according to at least certain embodiments employing either optical or conductive communication channels—may be arranged to function in low energy mode. In certain embodiments, such low energy mode may be facilitated by arranging nodes to assume default modes where they may be substantially inactive (i.e. ‘sleep’ mode).

Possibly, in such sleep mode, nodes may exhibit relative low energy e.g., current consumption, e.g. generally between about 1.0-2.5 μA (or the like).

In at least certain embodiments, each node may comprise an intermediate component (IC) possibly in form of a receiver for receiving incoming optical and/or electrical signals.

Possibly, signals arriving at a receiver of a node while in a ‘sleep’ mode and exceeding a minimum threshold level (e.g. optical intensity level or current and/or voltage level) and/or complying with a certain pre-defined pattern (e.g. frequency), may be arranged to function as a ‘wakeup’ signal for triggering the node into an ‘active’ mode.

Such ‘wakeup’ optical signal may be embodied as a preamble of an incoming message arriving at a receiver.

In certain embodiments, nodes may be arranged to return to an inactive ‘sleep’ mode upon completion of all the tasks resulting from an incoming message.

In at least certain embodiments and aspects defined herein, such infrastructure may be demonstrated as irrigation infrastructure that may be laid along paths in a field for growing crops, however as also demonstrated herein—aspects and/or embodiments should be considered in a broader sense for a variety of infrastructures. Other types of infrastructure coming within the scope of the present disclosure may include electrical cables or wirings, liquid or gas conducting conduits laid along paths on or below ground (and the like).

In certain embodiments, an infrastructural system in the field of agriculture may comprise a plurality of irrigation lines. In certain embodiments, each irrigation line may comprise a conducting tube and a plurality of emitting line segments (for example dripper line segments) associated with each conducting tube. Possibly, the diameters of a conducting tube and its associated emitting line segments may be different.

In a non-binding example, a diameter of a conducting tube may range from about 16 mm to about 20 mm and a diameter of an emitting line segment associated therewith may range from about 8 mm to about 14 mm.

Irrigation lines coming within the scope of the present disclosure may be of varying lengths. For example, in certain embodiments irrigation lines may range from about 200 meters to about 800 meters. Emitting line segments may range in length in one example from about 15 meters to about 50 meters.

In an aspect of the present invention, an irrigation system according to at least certain embodiments may comprise a plurality of control nodes located along each irrigation line or conducting tube.

Each node may be located in-between a downstream end of an upstream emitting segment and an upstream end of a downstream emitting segment.

In an embodiment, each node may be associated and/or in communication with an upstream and/or downstream emitting segment and/or conducting tube.

Nodes in at least most embodiments may be arranged to comprise a valve in liquid communicating with upstream and/or downstream emitting segments.

Valves in liquid communication with a conducting tube may preferably be arranged to control branching off of substances (e.g. liquid) from the conducting tube to a downstream emitting segment.

Valves in liquid communication with an upstream emitting segment may be arranged to control liquid communication between a downstream end of the upstream emitting segment and the ambient environment for possibly flushing liquid out of the downstream end of such upstream emitting segment to the ambient environment.

In an embodiment, a node may be arranged to activate its valve in order to perform various hydraulic actions. A hydraulic action may include irrigation and/or flushing of liquid out of an emitting segment associated to the node.

A control node may also be arranged to sense and/or collect data from the transceivers, valves, irrigation line and/or the environment adjacent the node.

An aspect of the present invention may be defined as relating to network communication between node embodiments.

In certain embodiments, nodes along an irrigation or conducting tube may be arranged for communication via one or more communication channels (e.g. optical fibers, conductive wires, etc.) extending along a length of a conducting tube.

Communication channels in form of optical fibers according to certain embodiments of the invention may be plastic optical fiber (POF). Plastic optical fibers are typically of a relative low cost, can be easily integrated with polymer irrigation pipe such as polyethylene, and can be relatively easily spliced in field conditions.

Optical fibers according to certain embodiments of the invention may be arranged for linear bus topology in which nodes are connected one after the other in a sequential chain.

In at least certain embodiments, communicating via communication channels over a network communication may comprise multi-hop routing where a node can use other nodes as relays. Possibly, such multi-hop routing may be in the form of a daisy chain topology where multiple nodes are wired together in sequence. In some cases, said daisy chain topology may be a linear or tree daisy chain topology.

In such multi-hop routing, optical or electrical signals conveying messages and/or commands may be relayed between relatively closely sequential placed nodes that are spaced apart by relative short distances (e.g. about 50 meters apart or the like).

Such relaying from node to node may be in downstream and/or upstream directions along a conducting tube.

In embodiments comprising communication channels in form of optical fibers, such multi-hop routing between closely spaced apart nodes may facilitate use of optical fibers of relatively large fiber attenuation (such as in POF's) along relatively large distances, since loss of light in such embodiments may be mitigated by the relative short distance light travels between nodes.

Light emitted from a first node at an initial outgoing intensity typically arrives at a relative adjacent second node at a lower terminal intensity due to fiber attenuation. At the second subsequent and adjacent node, a command and/or message conveyed by the light signal may be interpreted, decoded and/or modulated and then relayed onwards away from such second node at an intensity generally similar to the initial outgoing intensity towards a third adjacent sequential node (and so on). In other words, a received light signal is boosted to its initial outgoing intensity, as it leaves each successive node along the line, and this boosting may occur in either or both the upstream and downstream directions

Such multi hop routing may thus permit relative large transmission ranges with fibers having relative high attenuation (such as POF's), however while keeping relative low overall fiber attenuation along the entire length of path that such messages traverse.

An aspect applicable to at least most embodiments of the invention may be defined as relating to reduction in power consumption and/or energy efficiency of systems. Such reduction in power consumption and/or energy efficiency may e.g. prolong battery life e.g. in batteries located in nodes and arranged to power nodes and/or actions activated/controlled by nodes.

For example, multi hop routing between relative closely spaced apart nodes (e.g. spaced apart by about 100 meter or less, for example about 50 meters or less) may reduce energy consumption relative to transmitting messages along longer distances e.g. 500 meters or more between nodes

Use of latch valves in (or in association with) at least certain node embodiments for controlling flow passages in systems employing such valves and/or nodes may contribute to energy savings. Latch valves are accordingly bi-stable in either shifted state, thus permitting energy savings by allowing a valve to stay in either state indefinitely without drawing power.

Energy savings may also be facilitated by configuring optical or electrical signals conveying messages and/or commands to comprise relatively low information capacity. For example, signals communicated along an infrastructure (e.g. piping infrastructure) may comprise an information capacity (e.g. “message length”) represented in bits of less than about 4000 or 2000 bits, possibly even less than a few hundred bits. In certain cases, messages and/or commands communicated along an infrastructure may comprise even less than about 100 bits, e.g. about 20 or 10 bits or even less than about 10 bits. The aforementioned 4000 bits may be arrived at in a scenario where the payload contains information returned from about 512 nodes along a line.

Reduction in power consumption may also be promoted by infrequently communicating new messages and/or commands along an infrastructure. For example, time gaps between subsequent new messages may be characterized by an infrequency in the order of about once or twice a day, possibly up to about 10 or 20 times a day.

Furthermore, to reduce power consumption, systems according to at least certain embodiments of the invention may be arranged to function in low energy mode. In certain embodiments, such low energy mode may comprise arranging nodes to assume default modes where they may be substantially inactive (i.e. ‘sleep’ mode).

Possibly, in such sleep mode, nodes may exhibit relative low current consumption, e.g. substantially between about 1.0-2.5 μA (or the like).

In at least certain embodiments, nodes may comprise a receiver for receiving incoming optical or electrical signals.

Possibly, signals arriving at a receiver of a node while in a ‘sleep’ mode, and exceeding a minimum threshold level and/or complying with a certain pattern, may be arranged to function as a ‘wakeup’ signal for triggering the node into an ‘active’ mode.

Such ‘wakeup’ optical/electrical signal may be embodied as a preamble of an incoming message arriving at a receiver.

In certain embodiments, nodes may be arranged to return to an inactive ‘sleep’ mode upon completion of all the tasks resulting from an incoming message.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows an infrastructural line, here embodied as a piping irrigation line in accordance with an embodiment of the present invention;

FIGS. 2A and 2B schematically show embodiments of nodes comprised in an infrastructural line such as the irrigation line in FIG. 1 utilizing optical fiber type communication channels for conveying signals between nodes;

FIGS. 3A and 3B schematically show embodiments of nodes comprised in an infrastructural line such as the irrigation line in FIG. 1 utilizing electrical conductive type communication channels for conveying signals between nodes;

FIG. 4 schematically shows an irrigation line and an embodiment of a communication network comprising node embodiments;

FIG. 5 schematically shows a plurality of irrigation lines in various modes of operation;

FIG. 6 schematically shows an embodiment of a communication network possibly used with various infrastructural lines disclosed herein; and

FIG. 7 schematically shows an embodiment of an irrigation line exhibiting a possible further mode of operation.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

Principles exemplified herein below with respect to infrastructural piping irrigation lines, should be taken in a general context as applicable to infrastructural lines in a broader sense, such as electrical cables or wirings, liquid or gas conducting piping laid on or below ground (etc.).

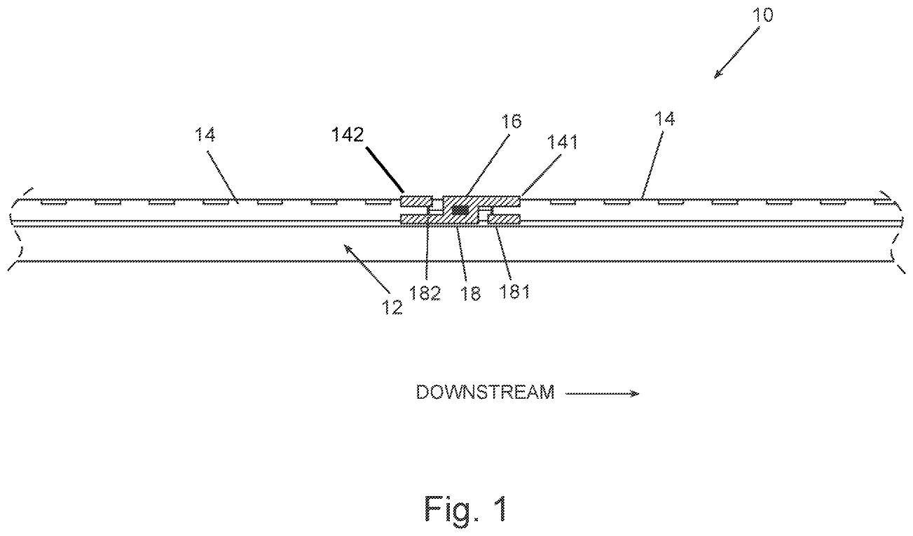

Attention is first drawn to FIG. 1 schematically illustrating an embodiment of an irrigation line 10. Irrigation line 10 here includes a conducting tube 12 for conducting irrigation substances to be irrigated to a field or crop.

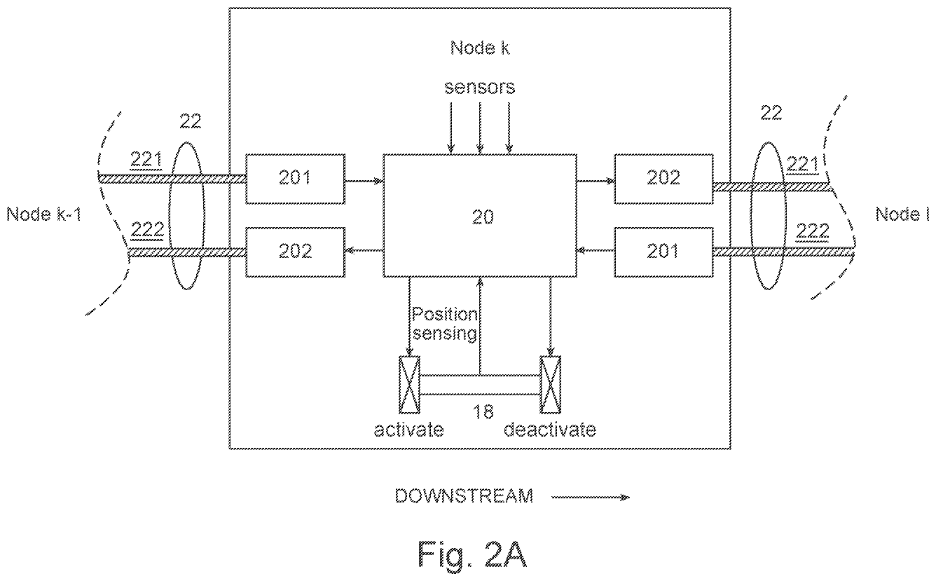

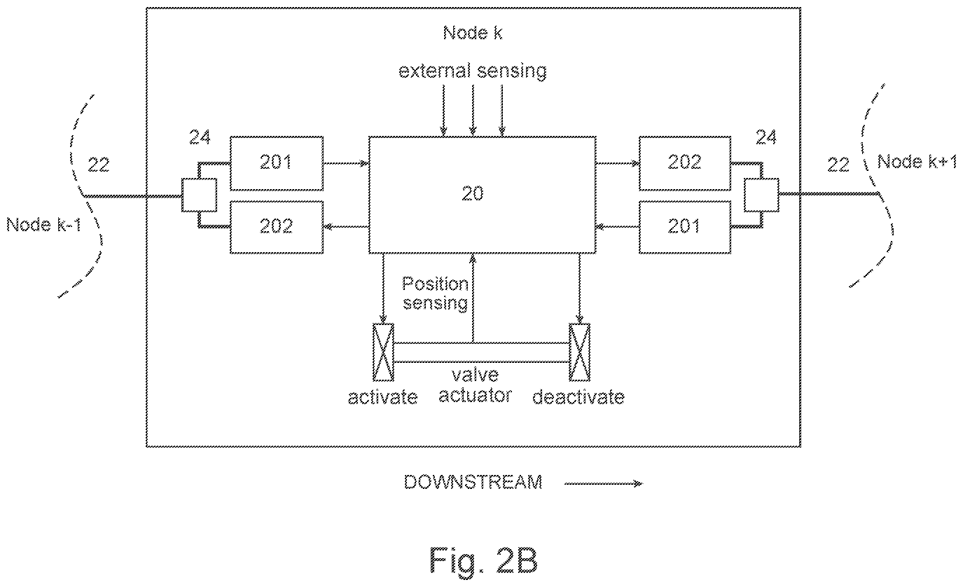

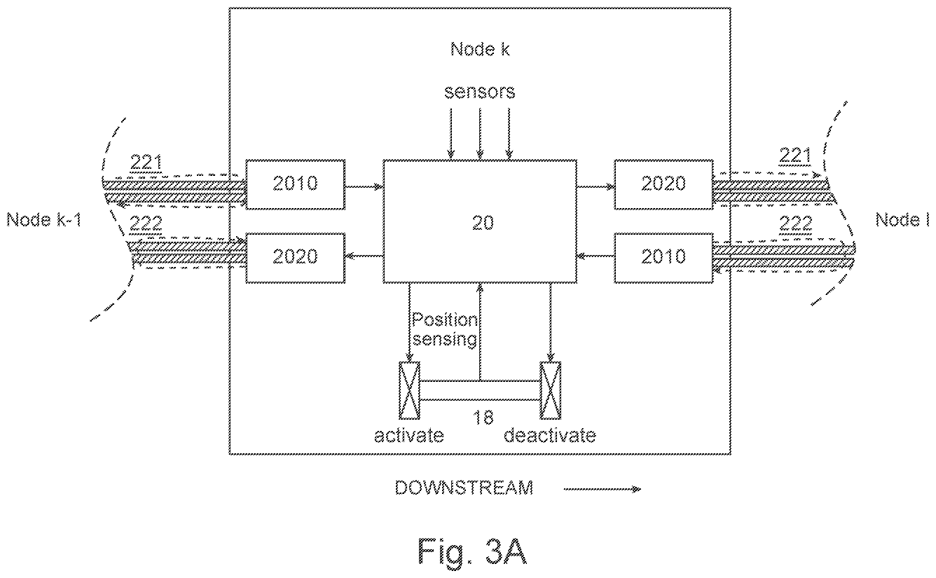

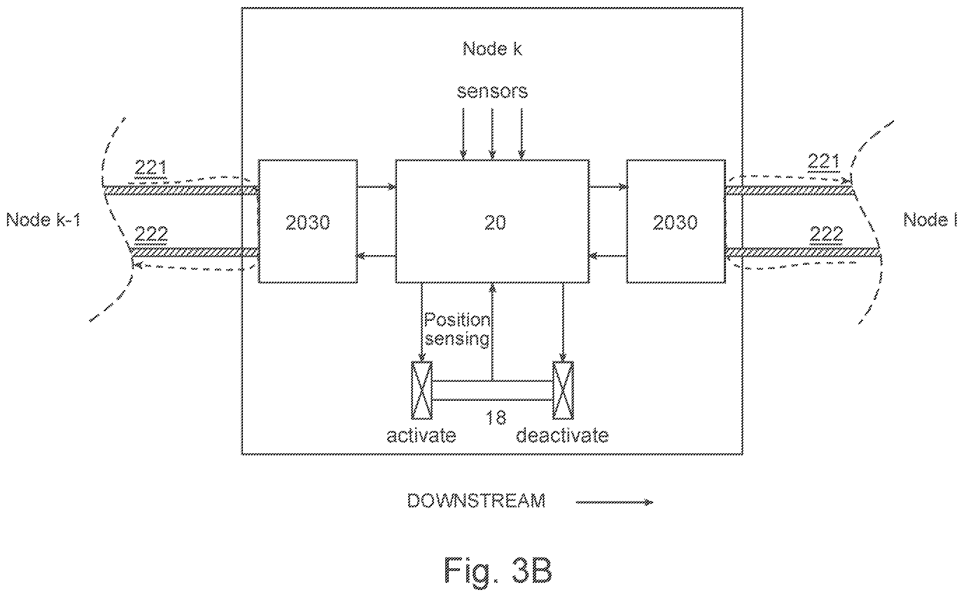

Irrigation line 10 in addition is shown including emitting segments 14 that extend along the irrigation line and nodes 16 located in between adjacent emitting segments. Node 16 described and shown in more detail e.g. in FIGS. 2 and 3—is here simply shown including a valve actuator element 18, however as detailed below, nodes may comprise in various embodiments additional elements.

Each emitting segment 14 has upstream and downstream ends 141, 142, with two such ends being seen in FIG. 1. In various embodiments, emitting segments 14 may take various forms suitable for emitting irrigation substances to the ambient environment. For example, an emitting segment may include irrigation drippers located along an emitting segment to form a so called dripping pipe.

Node 16 in this embodiment may be arranged via valve actuator 18 to communicate between conducting tube 12 and an emitting segment 14 located downstream of the node, in order to possibly permit controlled irrigation of liquid via irrigation emitters located along this emitting segment to crops in a field.

Node 16 in addition may be arranged in certain embodiments via valve actuator 18 (possibly the same valve actuator) to communicate between an emitting segment 14 located upstream and possibly the ambient environment, in order to permit controlled opening of a passage for flushing liquid out of this emitting segment to the ambient environment.

Node 16 may accordingly comprise a valve actuator 18 for controlling opening and closing of liquid passages to and from emitting segments, and/or to and from a conducting tube. In this example, valve actuator 18 includes two valve members 181, 182. One valve member 181 associated with an upstream end 141 of an emitting segment 14 located downstream to the node and another valve member 182 associated with a downstream end 142 of an emitting segment 14 located upstream to the node.

Attention is drawn to FIG. 2A schematically illustrating an enlarged view of a portion of a communication network in accordance with an embodiment of the present invention, here exemplifying a series of three nodes between which signals/information are communicated via communication channels here in form of optical fibers. The nodes here are, a central node K (fully illustrated), an upstream node K−1 and a downstream node K+1.

Taking node K as an example, each node in this embodiment is seen accordingly being linked in communication with its neighboring upstream node K−1 and downstream node K+1 via an optical fiber arrangement 22. In this example, the optical fiber arrangements 22 may be divided into first 221 and second 222 members. First member 221 may be arranged to communicate optical signals in a downstream direction and second member 222 may be arranged to communicate optical signals in an upstream direction.

Optical signals arriving at a node from neighboring nodes, are arranged to be communicated to a controller 20 of the node via a first intermediate component (IC) here in form of an optical receiver and possibly de-modulator (OR) 201. Optical signals outputted from a node to neighboring nodes, are arranged to be communicated outwards from the controller 20 of the node via a second intermediate component (IC) here in form of an optical transmitter and possibly modulator (OT) 202.

To reduce power consumption, systems according to at least certain embodiments employing either optical or conductive communication channels—may be arranged to function in low energy mode. In certain embodiments, such low energy mode may be facilitated by arranging nodes to assume default modes where they may be substantially inactive (i.e. ‘sleep’ mode).

Signals arriving at an intermediate component (IC) of a receiver type of a node while in a ‘sleep’ mode and exceeding a minimum threshold level (e.g. optical intensity level or current and/or voltage level) and/or complying with a certain pre-defined pattern (e.g. frequency), may be arranged to function as a ‘wakeup’ signal for triggering the node into an ‘active’ mode.

Optical receivers may be photodiodes, photo-transistors (or the like) and optical transmitters may be LEDs (or the like). In a non-binding example, an intermediate component (IC) of an optical receiver type suitable for at least certain node embodiments may be the PD70-01C/TR7 Photodiode from Everlight Electronics, or the SFH 3400 Phototransistor from OSRAM Opto Semiconductors Inc. (or the like); and an intermediate component (IC) of an optical transmitter type suitable for at least certain node embodiments may be the KPHHS-1005SURCK—LED from Kingbright Electronic Co., or the XZMDK68W-2 LED from SunLED corporation (or the like).

Optical receiver (OR) 201 may be arranged to transform incoming optical messages/signals to outgoing electrical messages/signals communicated towards controller 20. Optical transmitter (OT) 202 may be arranged to transform electrical messages/signals arriving from controller 20 to outgoing optical messages/signals communicated here towards an adjacent subsequent node.

In certain embodiments, an intermediate component (IC) of a bi-directional transceiver type (not shown in the figures)—suitable for both receiving and transmitting message to or from a node may be provided instead of separate components for receiving and transmitting messages. In a non-binding example such bi-directional transceiver may be the KPHHS-1005SURCK—LED from Kingbright Electronic Co., or the XZMDK68W-2 LED from SunLED corporation (or the like).

Each node may be arranged in certain embodiments to receive sensed data from sensing means either comprised in, associated with or linked in communication with the node. Such sensed data may be communicated outwards from the node, e.g. in a returning message communicated back upstream, thus possibly increasing the information capacity of messages upstream in relation to those communicated downstream. Each node in this embodiment may also include a valve actuator 18 that is arranged to activate and deactivate opening of liquid passages to and from the emitting segments and/or conducting tube. Possibly, valve actuator 18 may comprise a latch valve mechanism and by that contribute to reduction in energy consumption.

Attention is drawn to FIG. 2B illustrating a network of nodes generally similar to those in FIG. 2A, but here being arranged to include an optical fiber arrangement 22 made up of one fiber member. A beam splitter 24 receiving incoming or outgoing optical signals may be arranged to channel such signals to or from the optical fiber arrangement. The node in FIG. 2B thus exhibits a so-called half-duplex communication mode, where beam splitters are added to support single fiber use for both upstream and downstream communication.

Attention is drawn to FIG. 3A schematically illustrating an enlarged view of a communication network in accordance with an embodiment of the present invention, here exemplifying a series of three nodes between which signals/information are communicated via communication channel here in form of conductive wires. The nodes here are, a central node K (fully illustrated), an upstream node K−1 and a downstream node K+1.

Taking node K as an example, each node in this embodiment is seen accordingly being linked in communication with its neighboring upstream node K−1 and downstream node K+1 via a conductive wire arrangement. In this example, the conductive wire arrangement may be divided into first 221 and second 222 conductive wire members each including in this example two conductive wires forming electrical circuits (as illustrated by the ‘dashed’ arrows) for communicating electrical signals between adjacent nodes.

First conductive line member 221 may be arranged to communicate electrical signals in a downstream direction either into and out of a respective node, and second conductive line member 222 may be arranged to communicate electrical signals in an upstream direction into and out of a respective node.

Electrical signals arriving at a node from neighboring nodes, are arranged to be communicated towards a controller 20 of the node via an intermediate component (IC) here in form of a first one-directional galvanic isolator 2010 first (isolator circuit), and electrical signals outputted from a node to neighboring nodes, are arranged to be communicated outwards from the controller 20 of the node via a second intermediate component (IC) here also in form of a one-directional galvanic isolator 2020 (second isolator circuit).

To reduce power consumption, systems according to at least certain embodiments employing either optical or conductive communication channels—may be arranged to function in low energy mode. In certain embodiments, such low energy mode may be facilitated by arranging nodes to assume default modes where they may be substantially inactive (i.e. ‘sleep’ mode).

Signals arriving at an intermediate component (IC) of a node while in a ‘sleep’ mode and exceeding a minimum threshold level (e.g. optical intensity level or current and/or voltage level) and/or complying with a certain pre-defined pattern (e.g. frequency), may be arranged to function as a ‘wakeup’ signal for triggering the node into an ‘active’ mode.

Galvanic isolators may be used in at least certain embodiments for breaking ground loops and by that e.g. preventing unwanted or accidental current (e.g. due a lightening hitting the infrastructure) from flowing between nodes. In certain cases, lightening protection may be facilitated by provision of surge suppressors between nodes.

The galvanic isolators 2010, 2020 may be arranged to transform incoming electrical messages/signals to outgoing electrical messages/signals communicated towards or away from the controller 20.

Each node may be arranged in certain embodiments to receive sensed data from sensing means either comprised in, associated with or linked in communication with the node. Such sensed data may be communicated outwards from the node, e.g. in a returning message communicated back upstream thus possibly increasing the information capacity of messages upstream in relation to those communicated downstream. Each node in this embodiment may also include a valve actuator 18 that is arranged to activate and deactivate opening of liquid passages to and from the emitting segments and/or conducting tube. Possibly, valve actuator 18 may comprise a latch valve mechanism and by that contribute to reduction in energy consumption.

Attention is drawn to FIG. 3B illustrating a network of nodes generally similar to those in FIG. 3A, but here being arranged to include a conductive wire arrangement made up of one pair of conducting tubes. An intermediate component (IC) in form of a bi-directional galvanic isolator 2030 (bidirectional isolator circuit) receiving incoming or outgoing electrical signals may be arranged to channel such signals from a conductive line arrangement towards a node's controller or from such controller towards a conductive line arrangement.

In a non-binding example, bi-directional galvanic isolator 2030 may be the ACSL-7210 of Broadcom Inc. It is noted that same ACSL-7210 may also be used as a uni-directional galvanic isolator such as those indicated herein by numerals 2010, 2020.

Conductive wires coming within the scope of the various embodiments of the present invention, may be formed from conductive materials, such as copper, aluminum, conductive polymers (e.g. SIMONA PE-EL, Polycond, RTP Emi 162, Pre-elec) and the like.

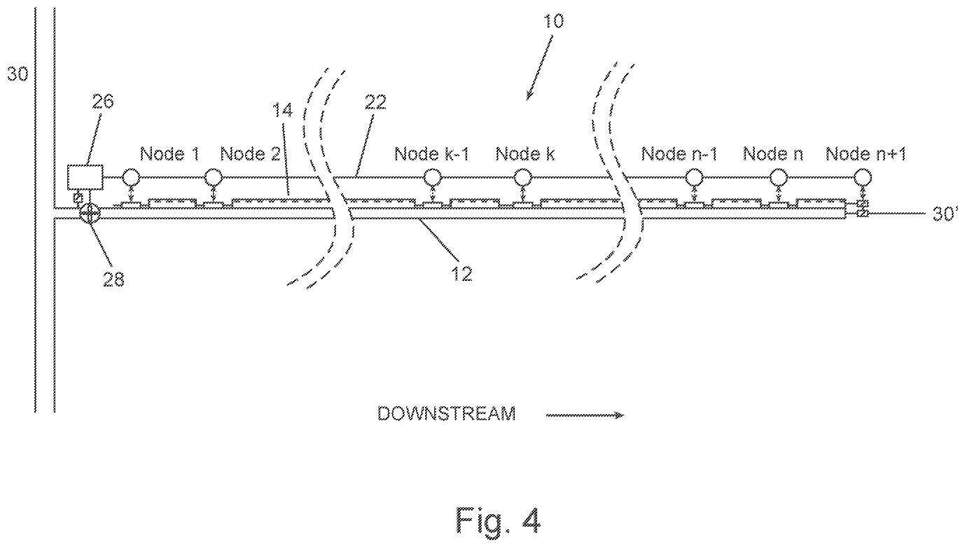

Attention is drawn to FIG. 4. In at least certain embodiments, line network topology may be pre-defined. Each node may be arranged to have an identification number representing its location along the network. The ID's may be attached and/or associated to the nodes when irrigation lines are installed in a field.

The system in FIG. 4 is also shown including a possible header line 30 (main pipe) for channeling liquid towards irrigation line 10. It is understood that the header line 30 supplies a plurality of such irrigation lines 10. In addition, the system in this embodiment is shown including a line network controller 26 for controlling nodes of the network and a possible water meter 28 at an upstream side of the conducting tube 12 and a possible pressure sensor 30′ at a downstream side of the irrigation line.

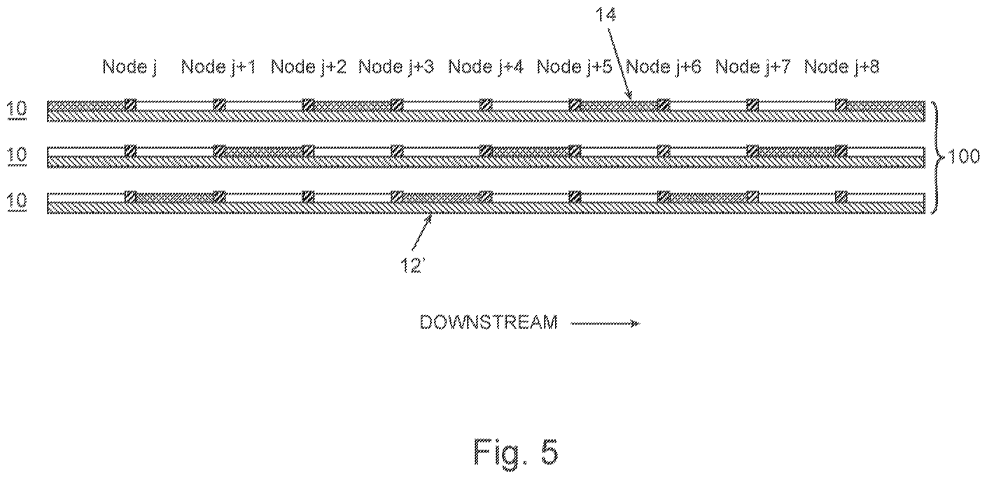

FIG. 5 illustrates a plurality of irrigation lines 10 placed generally alongside each other in a field to form an irrigation strip 100. In this example, hatch lines at the conducting tubes 12 represent these conducting tubes being pressurized with liquid. Hatch lines filling emitting segments 14 represent such segments as being activated e.g. for emitting and/or flushing liquid. It is understood that any such activation is facilitated by sending appropriate signals to the various nodes via the aforementioned optical fibers or conductive wires, associated with each irrigation line.

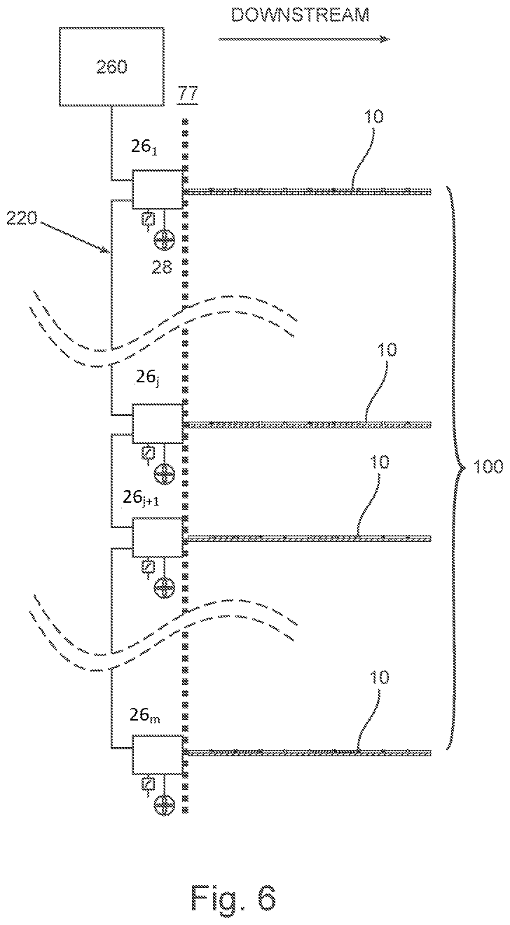

FIG. 6 illustrates an upstream end of an embodiment of an irrigation strip 100 generally similar to that in FIG. 5 here branching off from a header line 77 providing liquid to irrigation lines in strip 100 during an irrigation cycle. A possible strip/block/field controller 260 in this embodiment is shown in communication, possibly also via communication channels 220, with line controllers nodes 26 of the irrigation lines 10 using the same network principles described herein above.

The illustration in FIG. 6 may thus exemplify an infrastructure in the form of a header liquid line 77 that includes a plurality of control nodes 26 located therealong at regions where irrigation lines branch off from the header line. The control nodes 26 may be arranged to be in signal communication via communication channels 220 in form of optical fibers, or electrical conductors as those already described herein above. The control nodes 26 may be designed in a generally similar manner to the node embodiments illustrated and explained in FIGS. 2 and 3.

Messages arriving from controller 260 and e.g. triggering a node 26 into an ‘active’ mode—may be arranged to open or close a path for liquid from header line 77 to an irrigation 10 and/or activate any other action at the node (such as gathering sensed data, inquiring status of the node, etc.).

In some embodiments, each of the irrigation lines 10 seen in FIG. 6 may comprise a plurality of further nodes connected by either optical fibers or conductive wires. In such case, the signals sent by controller 260 contain addressing information sufficient to identify both the irrigation line (by addressing a particular line network controller 26i) as well as the particular node within the identified irrigation line 10.

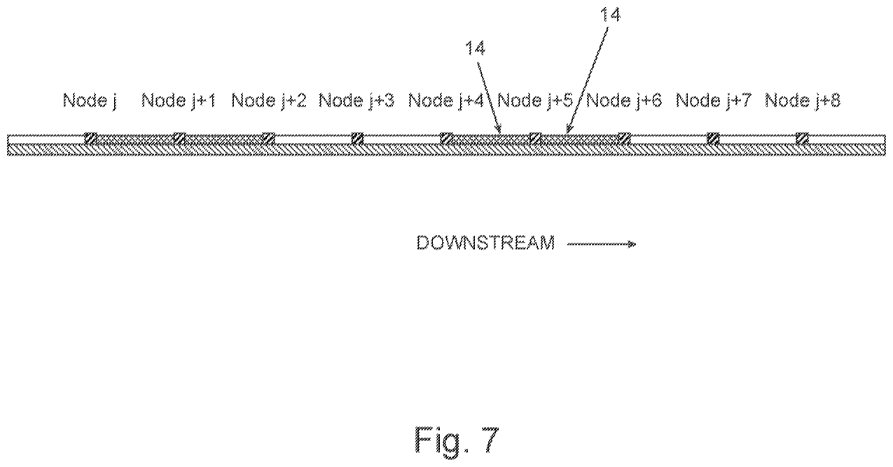

FIG. 7 represents an irrigation line where two adjacent emitting segments have been activated. A first one upstream to perform a flushing action and a second adjacent one downstream to perform an irrigation emitting action.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Furthermore, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

What is claimed is:

1. A fluid distribution system comprising:
a longitudinally extending piping infrastructure;
a plurality of nodes located along the infrastructure; and
communication channels extending along the infrastructure and communicating with the nodes, the communication channels and nodes configured to permit multi-hop routing of messages between nodes along the infrastructure; wherein:
the communication channels comprise plastic optical fibers (POFs).

2. The system of claim 1, wherein:
the nodes and communication channels are configured to operate in a daisy chain topology to implement said multi-hop routing.

3. The system of claim 1, wherein the messages comprise:
commands for activating valves along the infrastructure; and/or
sensed information collected from devices positioned along the infrastructure.

4. The system of claim 3, wherein said devices are comprised in nodes.

5. The system of claim 1, wherein:
the nodes are arranged in a linear bus topology and are connected by communication channels one after the other in a sequential chain.

6. The system of claim 1, wherein:
the communication channels and nodes are configured to permit multi-hop routing in both downstream upstream directions along the infrastructure.

7. The system of claim 1, wherein:
the nodes are configured to be in an inactive sleep mode until being activated by an incoming message comprising a wakeup signal.

8. The system of claim 7, wherein:
the wakeup signal is characterized by an incoming message exceeding a minimum threshold level and/or complying with a pre-defined pattern.

9. The system of claim 7, wherein:
the wakeup signal is comprised in a preamble of the incoming message.

10. The system of claim 7, wherein:
the nodes are configured to return to the substantial inactive sleep mode after completing one or more tasks performed in response to the incoming message.

11. The system of claim 1, wherein:
the system is an irrigation system; and
the pipe infrastructure comprises at least one irrigation pipe configured to deliver irrigation liquid.

12. The system of claim 11, wherein:
the at least one irrigation pipe is a header pipe from which irrigation lines branch off, and at least some of the nodes are arranged to control flow of liquid from the header pipe towards the irrigation lines.

13. The system of claim 12, wherein:
each node is associated with a respective one of the irrigation lines and is arranged to control liquid flow from the header pipe to its associated irrigation line.

14. The system of claim 11, wherein:
the piping infrastructure comprises at least one conducting tube and a plurality of emitting line segments associated with each conducting tube;
at least one node is connected to: an upstream end of a first emitting line segment located directly downstream of said at least one node; and a downstream end of a second emitting line segment located directly upstream of said at least one node; and
the at least one node is configured to open or close a liquid passage between the conducting tube and said first and/or second emitting line segment, in response to a message received over the communication channels.

15. The system of claim 43, wherein said at least one node further comprises:
a controller; and
a valve actuator connected to the controller and configured to selectively open or close said liquid passage.

16. The fluid distribution system of claim 15, wherein:
the valve actuator includes two valve members, a first valve member associated with said upstream end of the first emitting segment and a second valve member associated with said downstream end of the second emitting segment.

17. The system of claim 14, wherein:
the conducting tube has a diameter greater than that of an emitting line segment.

18. The system of claim 1, wherein:
at least some of the nodes each comprises at least one intermediate component (IC);
messages communicated towards and/or away from said each node must first pass through said at least one intermediate component.

19. The system of claim 18, wherein said least one intermediate component (IC) includes:
an optical receiver and an optical transceiver on a downstream side of said each node; and
an optical receiver and an optical transceiver on an upstream side of said each node.

20. The system of claim 18, wherein the intermediate component (IC) includes:
a bi-directional transceiver on both a downstream side and an upstream side, of said each node.

21. The system of claim 18, wherein:
said each node is configured to be in an inactive sleep mode until being activated by an incoming message comprising a wakeup signal, the wakeup signal comprising a minimum threshold level and/or a pre-defined pattern; and
when in said inactive sleep mode, said each node is triggered into an active mode in response to such a wakeup signal received at said at least one intermediate component (IC).

22. The system of claim 21, wherein:
the wakeup signal embedded in a preamble of an incoming message arriving at said at least one intermediate component (IC).

23. A method for providing and operating a communication network along a fluid distribution system, the communication network having an upstream end and a downstream end, the method comprising:
providing a longitudinally extending piping infrastructure for fluid distribution;
providing a plurality of spaced apart nodes along the piping infrastructure;
interconnecting the nodes with plastic optical fibers; and
multi-hop routing messages between the nodes, via the plastic optical fibers.

24. The method of claim 23, comprising:
connecting the nodes in a daisy-chain topology; and
multi-hop routing messages in both downstream and upstream directions between the nodes.

25. The method of claim 24, wherein:
a given message communicated downstream and arriving at the downstream end of the communication network triggers formation of a return message that is communicated back upstream.

26. The method of claim 25, wherein:
an information capacity of the given message communicated downstream as measured at least adjacent the downstream end of the communication network is substantially equal to or less than an information capacity of the returning message as measured at least adjacent the upstream end of the communication network.

27. The method of claim 23, comprising:
spacing apart adjacent nodes along the piping infrastructure by about 100 meters.

28. The method of claim 23, wherein at least certain nodes along the piping infrastructure comprise latch valves.

29. The method of claim 23, wherein each message communicated along the communication network comprises less than about 4000 bits of information.

30. The method of claim 23, comprising multi-hopping no more than 20 message per day.

31. An irrigation system comprising:
a longitudinally extending header pipe;
a plurality of nodes located along the header pipe;
irrigation lines that branch off from the header pipe; and
communication channels extending along the header pipe for communicating with the nodes, wherein:
communication with the nodes is in downstream and/or upstream directions along the communication channels;
the communication channels comprise optical fibers; and
at least some of the nodes are arranged to control flow of liquid from the header pipe towards the irrigation lines.

32. The irrigation system of claim 31, wherein communication along the communication channels is by multi-hop routing of messages between nodes along the infrastructure.

33. The irrigation system of claim 31, wherein the irrigation lines are drip irrigation lines.

34. A control system for controlling operations along a longitudinally extending piping infrastructure of a fluid distribution system, the control system comprising:
a plurality of nodes located along the piping infrastructure; and
communication channels extending along the piping infrastructure and communicating with the nodes for permitting multi-hop routing of messages between nodes along the piping infrastructure; wherein:
the communication channels comprise optical fibers.

35. The system of claim 34, wherein the multi-hop routing is characterized by nodes using other nodes as relays in a daisy chain topology.

36. The system of claim 34, wherein the messages comprise:
commands for activating valves along the infrastructure; and/or
sensed information collected from devices positioned along the infrastructure.

37. The system of claim 36, wherein the devices are located at the nodes.

38. The system of claim 34, wherein the longitudinally extending piping infrastructure is part of an irrigation system.

39. The system of claim 38, wherein the irrigation system comprises:
a header pipe; and
irrigation lines branching off from the header pipe, the irrigation lines comprising drip emitters.

40. The system of claim 39, wherein the nodes are located along the header pipe for controlling flow of liquid from the header pipe towards the irrigation lines.

42. The system of claim 39, wherein the nodes are located along the irrigation lines for controlling drip irrigation along distinct sections of the irrigation lines.

43. A fluid distribution system comprising:
a longitudinally extending piping infrastructure;
a plurality of nodes located along the infrastructure; and
communication channels extending along the infrastructure and communicating with the nodes, the communication channels and nodes configured to permit multi-hop routing of messages between nodes along the infrastructure; wherein:
at least one of said nodes comprises at least one intermediate component (IC);
messages communicated towards and/or away from said at least one node must first pass through said at least one intermediate component; and
the at least one intermediate component comprises an optical receiver.

44. The fluid distribution system according to claim 43, wherein:
the system is an irrigation system; and
the pipe infrastructure comprises at least one irrigation pipe configured to deliver irrigation liquid.

45. The fluid distribution system of claim 44, wherein:
the piping infrastructure comprises at least one conducting tube and a plurality of emitting line segments associated with each conducting tube;
said at least one node is connected to: an upstream end of a first emitting line segment located directly downstream of said at least one node; and a downstream end of a second emitting line segment located directly upstream of said at least one node; and
said at least one node is configured to selectively open or close a liquid passage between the conducting tube and said first and/or second emitting line segment, in response to a message received over the communication channels.

46. The fluid distribution system of claim 45, wherein said at least one node further comprises:
a controller which is reached by optical signals arriving from neighboring nodes only after passing through said at least one intermediate component; and
a valve actuator connected to the controller and configured to selectively open or close said liquid passage.

47. The fluid distribution system of claim 46, wherein:
the valve actuator includes two valve members, a first valve member associated with said upstream end of the first emitting segment and a second valve member associated with said downstream end of the second emitting segment.
